(19) United States
(12) Patent Application Publication
(10) Pub. No.: US 2008/0268190 A1
(43) Pub. Date: Oct. 30, 2008

(54) DEGRADABLE, SOFT-FEEL NETTING

(76) Inventors: Guangda Shi, Woodbury, MN (US); Andrea L. Brosch, Eden Prairie, MN (US); Albert M. Giorgini, Lino Lakes, MN (US)

Correspondence Address: BROOKS KUSHMAN P.C., 1000 TOWN CENTER, TWENTY-SECOND FLOOR, SOUTHFIELD, MI, 48075, US

(21) Appl. No.: 12/112,786

(22) Filed: Apr. 30, 2008

Related U.S. Application Data
(60) Provisional application No. 60/914,858, filed on Apr. 30, 2007.

(51) Int. Cl. D04H 3/08; B29C 47/00; B65D 30/06

(52) U.S. Cl. 428/35.5; 428/107; 264/176.1; 428/109

(57) ABSTRACT

The present invention provides degradable extruded netting. The netting comprises a plurality of oriented interconnected strands that intersect during extrusion. At least some of the strands include a degradable composition comprising a stiffening agent, a degradable material and a crystallinity inhibiting agent. In some embodiments, the stiffening agent comprises a polylactic acid polymer, the degradable material comprises a polyester degradable plasticizer, and the crystallinity inhibiting agent comprises a starch-based polymer. In certain embodiments, the degradable composition may comprise 10 to 70 weight percent polylactic acid polymer, 15 to 75 weight percent polyester degradable plasticizer, and 5 to 30 weight percent starch-based polymer. In other embodiments, the degradable composition may further comprise a friction reducing additive.

### CROSS-REFERENCE TO RELATED APPLICATIONS

This application claims the benefit of U.S. provisional application Ser. No. 60/914,858 filed Apr. 30, 2007, which is incorporated herein by reference.

### BACKGROUND OF THE INVENTION

1. Field of the Invention

The present invention relates to degradable, soft-feel netting; composites made with the degradable netting; and methods for making the same.

2. Background Art

The process of continuous extrusion of plastic netting was introduced in the 1950s. Extruded netting includes strands extruded from a die and netting joints that can be formed either within the die or immediately outside the die. A variety of configurations are known, such as square, diamond, twill, etc. Some of the more common materials used to prepare extruded netting are polypropylene, polyethylene (for example linear low grades, and ethylene copolymers), nylon, polybutylene, and blends thereof.

Currently, one typical extrusion process for manufacturing plastic nets includes extruding plastic strands in an interconnecting network to provide a net-like structure. Typically, either a rotary or a reciprocating extrusion process is employed. Methods for practicing the reciprocating technique are well known. For instance, U.S. Pat. Nos. 3,700,521, 3,767,353, 3,723,218, 4,123,491, 4,152,479 and 4,190,692 each provide an apparatus and method for making nets by the continuous extrusion of individual plastic strands. These patents are herein incorporated by reference in their entirety.

These nets have found a number of uses in commerce. For example, these nets have found use as packaging netting, such as for onion and turkey bags, erosion control netting, agricultural netting, such as turf netting, turf wrap, hay bale and netting for industrial, filtration and home furnishings applications.

Netting has also found use in certain composites. In such composites the netting is laminated to one or more fabric overlays. Chief among such uses and composites are fabrics for disposable diapers, incontinent briefs, training pants, bandages, dressings, diaper holders and liners and feminine hygiene garments, medical gowns, medical drapes, mattress pads, blankets, sheets, clothing, consumer wipes and other like products, such as building and construction composites.

Since netting materials often find their way into the environment, either through their implanting as a result of their intended use, or as waste, it has become desirable to provide netting which is degradable. An example of a degradable plastic material is a biodegradable plastic material defined as plastic material that degrades as a result of the action of naturally occurring micro-organisms, such as bacteria, fungi and algae. Complete degradation tends to result in the plastic material being completely transformed into biomass, carbon dioxide and water.

In addition to being degradable, the netting must be capable of being made by extrusion. In certain, more common, extruded netting manufacturing processes, a plastic material is typically extruded though an annular die and quenched in a water tank. The extrusion typically takes a tubular form and a diamond strand configuration.

To be compatible with this type of web handling system, the polymer material used in the extruded product must be able to withstand being transformed from an annular tube to a collapsed tube. The material must be flexible enough that this transition does not cause any permanent damage to the netting. The netting's folding point is particularly sensitive to damage. Such damage can also affect performance in a subsequent orientation process step. For a given netting material, the greater its thickness, the more susceptible it will be to damage in this transformation process.

The tubular sheet typically will undergo an orientation process where it is expanded, or stretched, in one or two directions, with the orientation typically taking place in only the machine direction. Prior to orientation, the tubular netting is typically passed through a heated water bath to heat the netting above its glass transition temperature (Tg) but below its melting point. The polymeric material used to form the netting must also be able to withstand this orientation process. Problems tend to occur during orientation when the polymeric materials are an inhomogeneous blend of somewhat incompatible components. This can cause the netting to rip during the orientation process or result in netting that is unsatisfactorily weak.

PLA polymers are well known biodegradable polymers. However, they are typically high tensile modulus materials. As such, 100% PLA extruded netting, precisely because of the relatively high tensile modulus of PLA, does not perform well after extruding in the subsequent web handling and in the orientation portion of the process. Thereby, PLA is particularly unsuitable for use as an extruded netting material.

To be orientable, the degradable material composition must exhibit strain hardening at the orientation temperature, and its stress level in the upper half of the material's strain range must also exceed its yield stress level. In other words, the material must have a break stress higher than the yield stress and exhibit strain hardening between these two stress points. Typically, 100% PLA resins are extrudable, but do not exhibit sufficient flexibility to survive the netting manufacturing process, and are therefore not suitable for netting manufacturing processes. For a typical netting extrusion web handling system, the material needs to exhibit a certain degree of flexibility, in order for the material not to become damaged when bent or folded.

Plastic compositions such as mixtures of PLA polymers and polyester biodegradable plasticizers are also known. While these compositions can provide extruded nets, the resulting nets do not have sufficient softness to be used as bags for consumables, such as produce. Further, nets made of these compositions do not have sufficient elastic behavior, such as being capable of surviving the netting manufacturing process or the food packaging process like the process used with typical commercial bagging equipment for produce. An example of the high-volume commercial bagging process is rucking. The food packaging processors use a rucking method to prepare the net to accept produce. This process will accumulate thousands of feet of netting onto a short circular sleeve so it can be loaded into an automated packaging machine. The manufacturing and rucking processes require netting to be relatively soft, flexible, and slippery so it can fold over a mandrel, such as a sleeve, at high speed.

As such, the material used to make the netting must be able to be extrudable to form netting having desired structural properties, such as flexibility, orientability and tensile strength; tactile properties, such as softness; a relatively low coefficient of friction; and be degradable.

### SUMMARY OF THE INVENTION

In one embodiment of the present invention, degradable extruded netting is provided. In at least this embodiment, the netting comprises a plurality of oriented interconnected strands that intersect during extrusions with at least some of the strands including a degradable composition comprising a stiffening agent, a degradable material and a crystallinity inhibiting agent. In at least some embodiments, the degradable composition comprises 10 to 70 weight percent of a polylactic acid polymer, 15 to 75 weight percent of a polyester degradable plasticizer, and 5 to 30 weight percent of a starch-based polymer. In other embodiments, the degradable composition further comprises a friction reducing additive.

Another embodiment of the present invention is a method of making a degradable extruded netting. In at least one embodiment, the method comprises interconnecting a plurality of strands with at least some of the strands comprising a degradable composition including polylactic acid polymer, polyester degradable plasticizer, and starch-based polymer.

In yet another embodiment of the present invention, a degradable extruded netting is provided comprising a plurality of oriented tapes with at least some of the tapes comprising a degradable composition comprising a stiffening agent, a degradable material, and a crystallinity inhibiting agent. In at least this embodiment, the degradable extruded netting has a least one of the following properties:

a tensile strength greater than 5000 psi,

a tensile modulus greater than 96,000 psi,

an angle at which slippage begins for a sled-to-net test of less than 20.1 degrees,

or an angle at which slippage begins for a net-to-net test of less than 23.0 degrees.

### BRIEF DESCRIPTION OF THE DRAWINGS

FIG. 1 illustrates an embodiment of the present invention's netting in a commercial process for bagging produce;

FIG. 2a is a perspective view of an embodiment of the netting of the present invention;

FIG. 2b is a perspective view of another embodiment of the netting of the present invention;

FIG. 2c is a perspective view of another embodiment of the netting of the present invention;

FIG. 3 illustrates a ternary diagram of the break strain of certain embodiments of the netting of the present invention;

FIG. 4 is a ternary diagram of the yield strength of certain embodiments of the netting of the present invention; and

FIG. 5 is a ternary diagram of the smoothness of certain embodiments of the netting of the present invention.

### DETAILED DESCRIPTION OF THE PREFERRED EMBODIMENTS

Reference will now be made in detail to presently preferred compositions, embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

Except in the operating examples, or where otherwise expressly indicated, all numbers in this description indicating material amounts, reaction conditions, or uses are to be understood as modified by the word “about” in describing the invention's broadest scope. Practice within the numerical limits stated is generally preferred. Also, unless expressly stated to the contrary:
percent and ratio values are by weight;
the term “polymer” includes “oligomer,” “copolymer,” “terpolymer,” and the like;
a material group or class described as suitable or preferred for a given purpose in connection with the invention implies any two or more of these materials may be mixed and be equally suitable or preferred;
constituents described in chemical terms refer to the constituents at the time of addition to any combination specified in the description, and does not preclude chemical interactions among mixture constituents once mixed;
an acronym's first definition or other abbreviation applies to all subsequent uses here of the same abbreviation and mutatis mutandis to normal grammatical variations of the initially defined abbreviation; and
unless expressly stated to the contrary, measurement of a property is determined by the same technique as previously or later referenced for the same property.

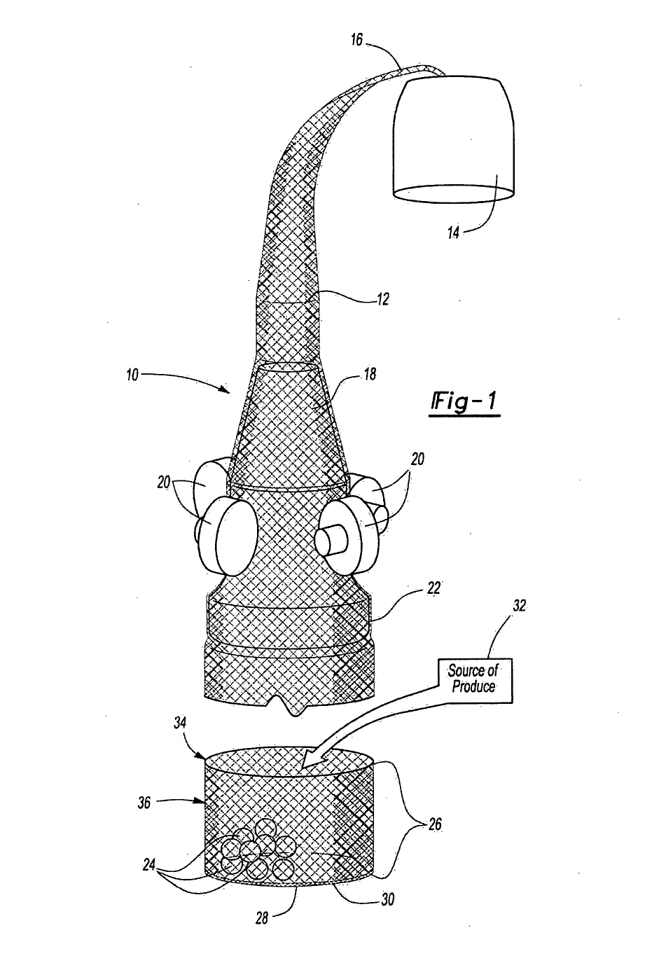

Referring now to FIG. 1, an exemplary produce bagging process, employing a rucking machine 10, is shown. The rucking machine 10 is used to expand netting 12 supplied to the rucking machine 10 from a tow 14 of collapsed and packaged netting 12. The netting 12 when collapsed in the form of a tow rope 16 is connected to the rucking machine 10. The netting 12 has an open end (not shown) that slides over a cone 18 of the rucking machine 10. The netting 12 is at least partially expanded as it passes down the cone 18 from the narrow top of the cone 18 to the base of the cone 18. Traction wheels 20 grab the netting 12 and continue to slide it on to a sleeve 22 of the rucking machine 10. When on sleeve 22, the netting 12, previously collapsed on the tow rope 16, has now been opened and is suitable for packaging produce 24. While produce 24 shown in FIG. 1 is illustrated to be onions, it should be understood that any product can be employed with the netting of the present invention. The sleeve 22 of netting 12 is pulled from a magazine (not shown) which holds the sleeve 22 on the rucking machine 10. The sleeve 22 is placed on a produce packaging machine (not shown). As the netting 12 is fed from sleeve 22, portions of the netting are opened to define an opening at a header 26. One header 26 located at the bottom 28 of a bag 36 is sewn closed with a thread 30. Another header 26 at the opposite end or top of the bag 36 receives produce 24.

The produce 24 is provided from a source 32 and enters an opening 34 in the bag 36 at the top header 26. When the bag 36 is full with produce 24, the opening 34 in the bag 36 is then sealed. The result is the bag 36 of produce 24 ready for shipment and retail sale.

It is advantageous for the material of the netting 12 (or bag 36) to be degradable and/or compostable after its service life is completed. At least one embodiment of the present invention includes netting 12, which is degradable and compostable. Concurrently, the netting 12 is sufficiently soft, elastic, and slippery to be suitable for use with high speed commercial packaging equipment such as the rucking machine 10.

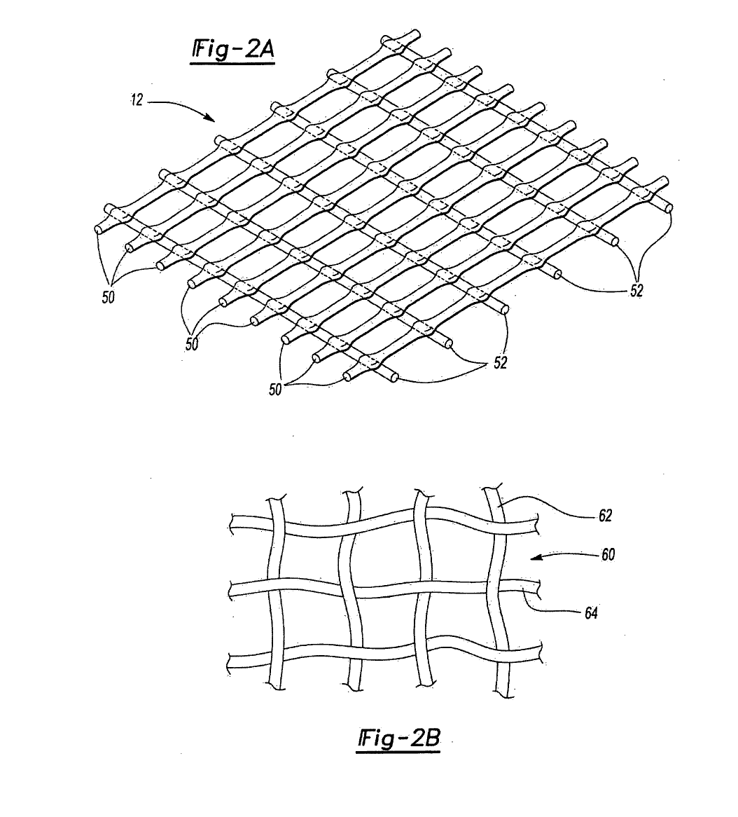

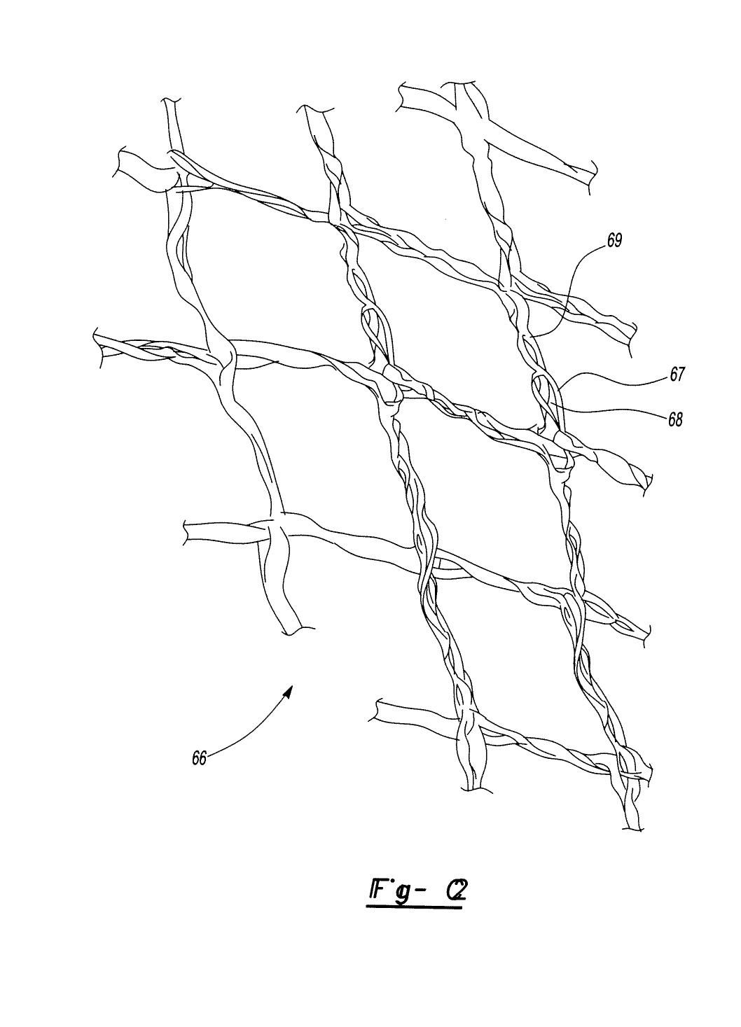

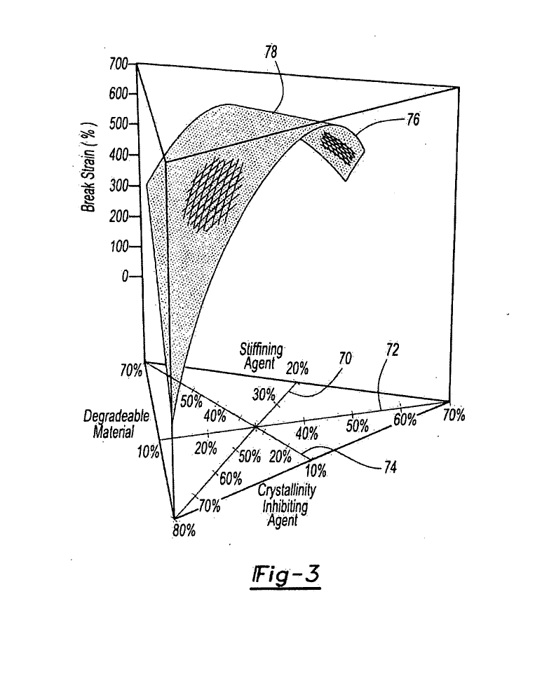

Referring now to FIG. 2a, an exemplary netting 12 configuration assembly is shown, which is usable under the present invention. The netting 12 comprises strands 50 extending in one direction and strands 52 extending in a generally crosswise or transverse direction. The strands 50 and 52 are extruded polymeric elongate members which cross and intersect during extrusion to form the net-like structure. While shown in a diamond configuration, it should be understood that the strands 50 and 52 could be arranged in any suitable configuration. Further, while the netting 12 is illustrated in flat form, it should be understood that the netting could have a tubular form. In at least one embodiment, the strands 50 and 52 are made of the same material. In certain embodiments where the strands 50 and 52 are made in the combinations of strand materials disclosed above and comprise the same material, the material comprising the strands 50 and 52 is a degradable composition. In still yet other embodiments, at least 60% of the strands 50 and 52 are made of the degradable composition, while in other embodiments, essentially 100% of the strands 50 and 52 are made of the degradable composition.

In at least another embodiment, strands 50 are made of a different material than strands 52. In this embodiment, the netting 12 may comprise 10 to 90 wt % of the material comprising strands 50 and 10 to 90 wt % of the material comprising strands 52. In other embodiments, the netting may comprise 35 to 65 wt % of the material comprising strands 50 and 35 to 65 wt % of the material comprising strands 52. In yet other embodiments, the netting may comprise 45 to 55 wt % of the material comprising strands 50 and 45 to 55 wt % of the material comprising strands 52.

In certain embodiments where the strands 50 and 52 are made in the combinations of strand materials disclosed above, the material comprising the strands 50 and 52 is a degradable composition. In still yet other embodiments, at least 60% of the strands 50 and 52 are made of the degradable composition, while in other embodiments, essentially 100% of the strands 50 and 52 are made of the degradable composition.

When a material other than the degradable composition is used to manufacture at least some portions of at least one of the sets of strands 50 or 52, such material may comprise a non- or a lesser degradable material. Any such suitable other material could be used such as elastomeric materials such as styrenic block copolymers, Hytrel®, and Santoprene® and polyurethane, polyester, and polyamide thermoplastic elastomers. The other (i.e., non- or lesser degradable) material may also comprise non-elastomeric materials such as nylons, polyesters, polypropylene, polyethylenes including HDPE and copolymers of such resins, with the polyolefins being preferred and with polypropylene being especially preferred. The non- or lesser degradable material may also include a polyolefin hybrid, such as BioPolyolefin™ supplied by Cereplast; a recycled; or a reused plastic including a mixed material recyclate. The recyclate may include a layered film material where the layered films were formed prior to recycling or reuse.

In some embodiments, the extruded netting 12 has strands that have an average thickness (i.e., diameter) of 1 to 300 mils (0.02 mm to 8 mm), in other embodiments 2 to 150 mils (0.05 mm to 3.8 mm), and in yet other embodiments 5 to 40 mils (0.01 mm to 1 mm).

Referring now to FIG. 2b, the present invention provides an exemplary woven netting 60. The netting 60 comprises tapes 62 extending in one direction and tapes 64 extending in a generally crosswise or traverse direction. The tapes 62 and 64 may be extruded as a film of polymeric material which is subsequently slit into tapes. In at least one embodiment, the tapes 62 and 64 are made of the same material.

In at least another embodiment, tape 62 is made of a different material than tape 64. In this embodiment, the netting may comprise 10 to 90 wt % of the material comprising tape 62 and 10 to 90 wt % of material comprising tape 64. In other embodiments, the netting may comprise 30 to 65 wt % of the material comprising tape 62 and 30 to 65 wt % of the material comprising tape 64. In yet other embodiments, the netting may comprise 45 to 55 wt % of the material comprising tape 62 and 45 to 55 wt % of the material comprising tape 64.

In certain embodiments where the tapes 62 and 64 are made in the combinations of tape materials disclosed above, the material comprising the tapes 62 and 64 is a degradable composition. In still other embodiments, at least 60% of the tapes 62 and 64 are made of degradable composition, while in other embodiments, substantially 100% of the tapes 62 and 64 are made of degradable composition.

In another embodiment, the width of the tape may be selected independently from greater than 0.5 mm, 1 mm, 2 mm, 5 mm, 15 mm, 25 mm, or 50 mm to less than 100 mm, 75 mm, 60 mm, 50 mm, or 25 mm. The range of thickness of the tapes 62 and 64 may be independently selected from greater than 0.002 mm, 0.005 mm, 0.0075 mm, 0.01 mm, 0.015 mm, 0.0300 mm, 0.05 mm, 0.075 mm, 0.1 mm, or 0.15 mm to less than 10 mm, 5 mm, 2 mm, 1 mm, or 0.5 mm.

The range of tensile strength of tapes 62 and 64 as well as strands 50 and 52 may be independently selected from greater than 3,000 psi (20.6 MPa), 4,000 psi (27.6 MPa), or 5,000 psi (34.4 MPa) to less than 11,150 psi (76.8 MPa), 9,000 psi (62 MPa), or 7,000 psi (48.2 MPa) when measured using ASTM D-882. The range of tensile modulus of tapes 62 and 64 as well as strands 50 and 52 may be independently selected from greater than 50,000 psi (344 MPa), 80,000 psi (550 MPa), 110,000 psi (758 MPa), 120,000 psi (827 MPa), or 125,000 (860 MPa) psi to less than 300,000 psi (2,070 MPa), 280,000 psi (1,930 MPa), 250,000 psi (1,725 MPa), 225,000 psi (1,550 MPa), or 200,000 psi (1,380 MPa) when measured using ASTM D-882.

Referring now to FIG. 2c, the present invention provides an exemplary knitted netting 60. The netting 66 comprises tapes 67 and tapes 68 extending in a generally linear direction. The tapes 68 may be intertwined within a lineal 69. Lineal 69 may extend in a generally crosswise or transverse direction. The tapes 67 and 68 may be extruded as a film of polymeric material which is subsequently slit into tapes. In at least one embodiment, the tapes 67 and 68 are made of the same material and these tapes 67 and 68 are formed in a single lineal, such as lineal 69.

In at least another embodiment, tape 67 is made of a different material than tape 68 within lineal 69. In this embodiment, the netting 66 or the individual lineals 69 may comprise 10 to 90 wt % of the material comprising tape 67 and 10 to 90 wt % of material comprising tape 68. In other embodiments, the netting may comprise 30 to 65 wt % of the material comprising tape 67 and 30 to 65 wt % of the material comprising tape 68. In yet other embodiments, the netting may comprise 45 to 55 wt % of the material comprising tape 67 and 45 to 55 wt % of the material comprising tape 68.

In certain embodiments where the tapes 67 and 68 are made in the combinations of tape materials disclosed above, the material comprising the tapes 67 and 68 is a degradable composition. In still other embodiments, at least 60% of the tapes 67 and 68 are made of degradable composition, while in other embodiments, substantially 100% of the tapes 67 and 68 are made of degradable composition.

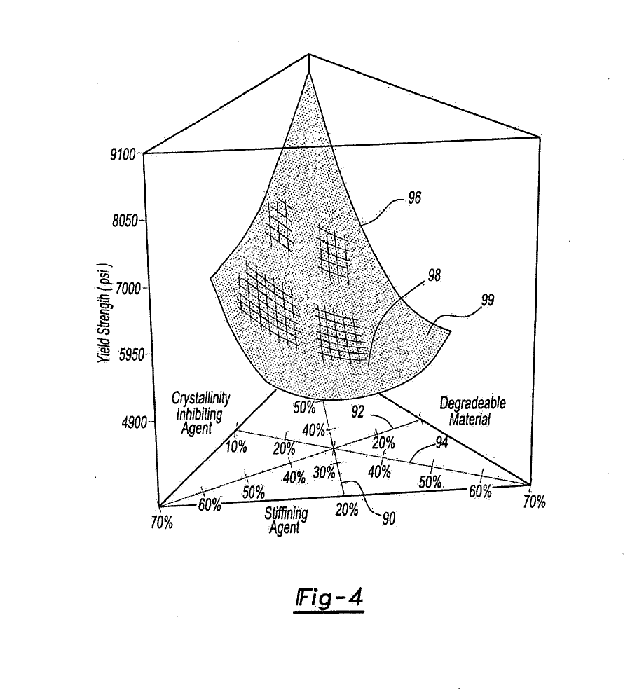

Referring now to FIG. 3, a representative ternary diagram regarding material components illustrates the break strain percentage for a series of compositions. A stiffening agent composition by weight percentage is given on an axis 70. An axis 72 for degradable material composition by weight percentage and an axis 74 for crystallinity inhibiting agent by weight percentage when combined with axis 70 define a compositional space. As shown in FIG. 3, the response surface 76 exhibits a optimal ridge 78 for break strain representing compositions having surprisingly advantageous softness and degradability properties.

Referring now to FIG. 4, the yield strength is illustrated for the similar representative compositional space as in FIG. 3. Yield strength measures the amount of stress at which point the material will begin to deform drastically and will not return to its original shape. The stress experienced by produce bag materials during rucking and filling operations mean that a high yield stress netting is advantageous. The axis 90 for the stiffening agent by weight percentage, a degradable material by weight percentage axis 92, and a crystallinity inhibiting agent by weight percentage axis 94 illustrate certain embodiments of the compositions of materials in this invention. A response surface 96 for yield strength shows that the yield strength responds non-linearly to additions of degradable material and crystallinity inhibiting agent. Degradable material and crystallinity inhibiting agents traditionally have been viewed as decreasing the mechanical properties of stiffened formulations. The response surface 96 seems to follow the traditional expectation until reaching a ridge 98 of relatively low yield strength. But, an area 99 has an unexpected increase in yield strength in some regions having relatively high weight percentages of degradable material and crystallinity inhibiting agent. While not wishing to be bound to any one theory, this curved response surface 96 may indicate that degradable material and crystallinity inhibiting agent components may interact to provide relatively higher yield strength than would be expected from a linearly decreasing mechanical property that is traditionally expected.

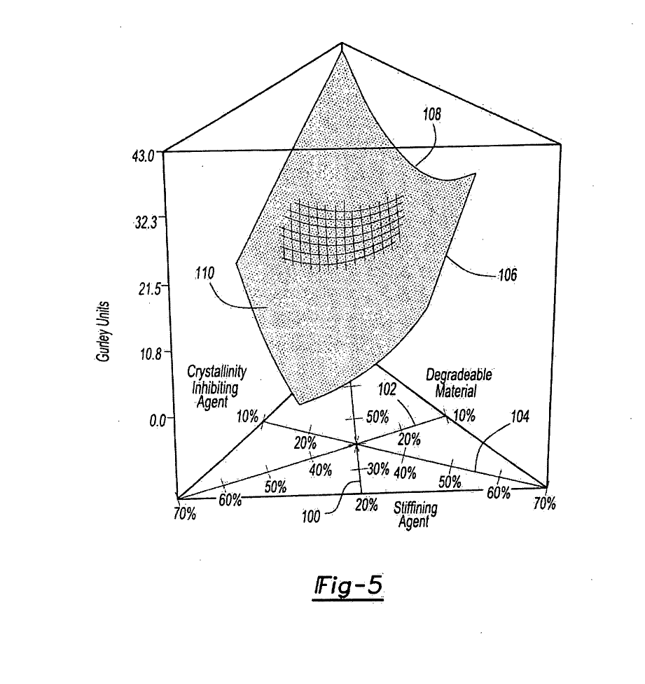

Referring now to FIG. 5, a representative ternary diagram is shown with a composition percentage by weight of stiffening agent axis 100, a degradable material axis 102, and a crystallinity inhibiting agent axis 104. A response surface 106 is expressed as Gurley units, which represent a measure of softness. Response surface 106 is relatively moderately non-linear having a ridge 108 of relatively low softness, and a region 110 having unexpectedly increased softness relative to the traditional expected decreasing linear response when using more degradable material and crystallinity inhibiting agent.

In certain embodiments, the degradable composition comprises the stiffening agent, such as a polylactic acid polymer, the degradable material such as a degradable plasticizer, a non-limiting example of which is a polyester biodegradable plasticizer, and the crystallinity inhibiting agent, such as a starch-based polymer. The degradable material may also include materials that are biodegradable, oxo-biodegradable, and/or oxo-degradable. The degradable composition may also comprise a polyolefinic material such as polyethylene or polypropylene. Furthermore, the degradable composition may also comprise additives, some of which are typically added to such degradable compositions and some of which may enhance properties, such a friction reducing additive, non-limiting examples of which include a slip additive and/or an anti-block additive. A degradability measure of the degradable composition includes the compostability of the material as determined by ASTM D-6400.

In certain embodiments, the range of weight loss percentage of the netting after the netting is exposed to test conditions in accordance with ASTM D-6400 may be independently selected from at least 70 wt %, 80 wt %, 90 wt %, or 95 wt % to no more than 100 wt %, 99 wt %, 95 wt %, 91 wt %, or 90 wt %. In another embodiment, 100 wt % of the netting is lost when the netting is exposed to test conditions in accordance with ASTM D-6400.

In certain embodiments, a biodegradable composition comprises polylactic acid polymer, polyester biodegradable plasticizer, and starch-based polymer. The composition may also comprise polyolefinic materials such as polyethylene or polypropylene. Furthermore, the biodegradable composition may also comprise additives. In at least one embodiment, the biodegradable composition may comprise 10 wt % to 70 wt % polylactic acid polymer, 20 wt % to 60 wt % polyester biodegradable plasticizer, and 10 wt % to 30 wt % starch-based polymer. In at least another embodiment the biodegradable composition may comprise 30 wt % to 50 wt % polylactic acid polymer, 30 wt % to 55 wt % polyester biodegradable plasticizer, and 10 wt % to 20 wt % starch-based polymer.

In certain other embodiments, the degradable composition comprises, in weight percent, based on the total weight of the composition:

| | Preferred Range | More Preferred | Most Preferred |
|---|---|---|---|
| Components | (wt %) | Range (wt %) | Range (wt %) |
| Polylactic Acid | 10% to 70% | 15% to 40% | 20% to 30% |
| Polymer | | | |
| Degradable | 15% to 75% | 20% to 65% | 35% to 65% |
| Plasticizer | | | |
| Starch-based | 5% to 30% | 5% to 20% | 7% to 15% |
| Polymer | | | |
| Polyolefin | 0% to 20% | 0% to 10% | 0% |
| Additives | 0% to 20% | 0% to 10% | 0% to 2% |

In certain embodiments, the degradable, soft-feel netting has additional fitness for use requirements when used in certain commercial applications. Typical degradable materials, such as compostable materials, which may include biodegradable materials, do not tend to slide well. In certain instances, the degradable material tears when applied to the rucking machine 22 (FIG. 1). Tears can occur, for example, when the traction wheels 20 rotate 60 to 100 revolutions per minute. When compostable materials have relatively high coefficients of friction, the netting 12 may not slide quickly enough and the traction wheels 20 tear holes through the netting by physical tearing. The friction reducing additive may increase a slip and/or an anti-block property of the composition sufficiently to allow surprisingly good use with commercial rucking machines such as rucking machine 10.

In general, the polylactic acid polymer can comprise a stiffening agent, such as polylactide or polylactic acid (polylactide and polylactic acid being referred to, collectively, herein as polylactide or PLA).

In general, polymer nomenclature sometimes references polymers on the basis of the monomer from which the polymer is made, and in other instances characterizes the polymer based upon the smallest repeating unit found in the polymer. For example, the smallest repeating unit in polylactide is lactic acid (actually residues of lactic acid). However, in typical instances, commercial polylactide will be manufactured by polymerization of lactide monomer, rather than lactic acid. Lactide monomer, of course, is a dimer of lactic acid. Herein the terms “polylactic acid,” “polylactide,” and “PLA” are intended to include within their scope both polylactic acid-based polymers and polylactide based polymers, with the terms used interchangeably. That is, the terms “polylactic acid,” “polylactide,” and “PLA” are not intended to be limiting with respect to the manner in which the polymer is formed.

The term “polylactide based” polymer or “polylactic acid based” polymer is meant to refer to polymers of polylactic acid or polylactide, as well as copolymers of lactic acid or lactide, wherein the resulting polymer comprises at least 50%, by weight, lactic acid residue repeating units or lactide residue repeating units. In this context, the term “lactic acid residue repeating unit” is meant to refer to the following unit:

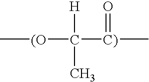

In view of the above definition, it should be clear that polylactide can be referred to both as a lactic acid residue containing polymer and as a lactide residue containing polymer. Herein the term “lactide residue repeating unit” is meant to refer to the following repeating unit:

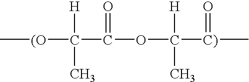

It should be appreciated that the lactide residue repeating unit can be obtained from L-lactide, D-lactide, and meso-lactide. The L-lactide is structured from two S-lactic acid residuals; the D-lactide is structured from two R-lactic acid residuals; and the meso-lactide is structured from both an S-lactic acid residual and an R-lactic acid residual.

Furthermore, it should be understood that the term “PLA” is not intended to limit a composition to one containing only polylactide or polylactic acid as the polymer component. As used herein, the term “PLA” covers compositions which contain a polymer containing the above-described lactic acid residue repeating unit in an amount of at least 50%, by weight, based on the total repeating units in the polymer. A PLA composition can include other components blended in with the polymer containing at least 50%, by weight, lactic acid repeating units. Generally, it is expected that at least 20% of the component will be comprised of a polylactide material. Preferably, the component will include at least 70% by weight polylactide, and more preferably at least 90% by weight polylactide, and even more most preferably 100%. It should be appreciated that the amount of polylactide present in a particular component depends on the desired property to be imparted to that component.

In at least one embodiment, usable PLA-based polymers according to the preferred techniques described herein, are prepared from polymerization of lactide or lactic acid. In some applications, the polymerization may be a copolymerization, with the lactide or lactic acid monomer copolymerized with another material. In some instances, the lactic acid or lactate may first be polymerized, with the resulting polymer mixture then being reacted, for example copolymerized, with another material in order to provide for some desired modification, for example relating to molecular weight or polydispersity.

Lactic acid residue containing polymers are particularly preferred for use in the present invention due to their hydrolyzable and biodegradable nature. One should recognize that polymers which provide similarly rapid degradation to naturally occurring end products can be useful in the present invention.

U.S. Pat. No. 5,142,023 issued to Gruber et al. on Aug. 25, 1992, the disclosure of which is hereby incorporated by reference, discloses, generally, a continuous process for the manufacture of lactide polymers from lactic acid. Related processes for generating purified lactide and creating polymers therefrom are disclosed in U.S. Pat. Nos. 5,247,058; 5,247,059; and 5,274,073 issued to Gruber et al., the disclosures of which are hereby incorporated by reference. It should be appreciated that selected polymers from these patents having the physical properties suitable for use in the present invention can be utilized. Generally, polymers according to U.S. Pat. No. 5,338,822 issued to Gruber et al. on Aug. 16, 1994 and U.S. Pat. No. 5,594,095 issued to Gruber et al. on Jan. 14, 1997, which are incorporated by reference, can be used in the present invention. Exemplary lactic acid residue containing polymers which can be used are described in U.S. Pat. Nos. 5,142,023; 5,274,059; 5,274,073; 5,258,488; 5,357,035; 5,338,822; 5,359,026; 5,484,881; 5,536,807; and 5,594,095, to Gruber et al., the disclosures of which are incorporated herein by reference.

It is desirable to provide the polylactide polymer with desired molecular weight ranges, polydispersity index (PDI), melt flow rate (MFR), tensile modulus and tensile strength. It should be appreciated that each of these, and other, properties can be adjusted for a given application.

In at least one embodiment, the polylactide polymer has a number average molecular weight (Mn) of between 25,000 and 200,000. In other embodiments, the number average molecular weight is between 75,000 and 150,000, and in yet other embodiments between 100,000 and 125,000. The measurement of number average molecular weight is preferably accomplished by GPC using polystyrene standards as described, for example, in U.S. Pat. No. 5,338,822.

In at least one embodiment, the polylactide polymer has a weight average molecular weight (Mw) of between 100,000 and 500,000. In other embodiments, the weight average molecular weight is between 125,000 and 250,000, and in yet other embodiments between 175,000 and 225,000. The measurement of weight average molecular weight is preferably accomplished by GPC using polystyrene standards as described, for example, in U.S. Pat. No. 5,338,822.

The PDI of the polylactide polymer is generally a function of branching or crosslinking and is a measure of the breadth of the molecular weight distribution. In certain embodiments the PDI (Mw/Mn) of the polylactide polymer is between 1.0 and 3.5, in other embodiments between 1.5 and 2.50, and in yet other embodiments between 1.7 and 2.25. Of course, increased bridging or crosslinking may increase the PDI.

Furthermore, the MFR of the polylactide polymer can be measured using standard ASTM D-1238, condition E, melt flow testing procedures which is at 190° C. with a 2.16 kg weight. In certain embodiments the polymer has a melt flow rate between 0.1 and 50 g/10 min., in other embodiments, between 0.5 and 25 g/10 min., in yet other embodiments between 1 and 15 g/10 min., in still yet other embodiments between 1 and 12 g/10 min., and in still yet another embodiment between 4 and 12 g/10 min.

In at least one embodiment, the polylactide polymer has a tensile modulus of between 475,000 and 750,000 psi. In other embodiments, the tensile modulus is between 480,000 and 600,000, and in yet other embodiments between 500,000 and 575,000. The measurement of tensile modulus is preferably accomplished by a tensile test in accordance with ASTM D-638.

In at least one embodiment, the polylactide polymer has a tensile strength at break of between 1,500 and 15,000 psi. In other embodiments, the tensile strength is between 4,000 and 10,000, and in yet other embodiments between 6,000 and 9,000. The measurement of tensile strength is preferably accomplished by ASTM D-638.

Suitable polylactic acid polymers include, but not necessarily limited to NatureWorks™ from Cargill Dow, LACEA from Mitsui Chemicals and Lacty from Shimadzu Seisakusho. In certain embodiments, polylactic acid polymers comprise PLA NatureWorks™ 5729B, 2002D, 4032 D and 5040D available from Cargill Dow. Cargill Dow 4032D is suitable for biaxial orientation yielding slightly improped mechanical properties of equivalent samples relative to the more readily available 2002 D grade. Suitable NatureWorks™ PLA materials may have the following characteristics:

Average Mw is 197,5000+/−5,400

Average Mn is 106,000+/−5,100

PDI equals Mw/Mn and is 1.86+/−0.10

Melt flow rate is 9.6+/−1.4 g/10 min

Tensile yield is 8,700 psi (60 MPa) according to ASTM D-882

Tensile strength at break is 7,700 psi (53 MPa) according to ASTM D-882

Tensile modulus is 536,000 (3,700 MPa) according to ASTM D-638 Other suitable PLA materials may have MFR's in the 4-8 g/10 min range.

It is understood that modified PLA materials, such as from Standridge Color, may also be suitable.

The polyester degradable plasticizer may be combinable with the polylactic acid polymer and the starch-based polymer. In particular, the degradable material may be a biodegradable material, such as Ecoflex® supplied by BASF, an oxo-degradable, such as d2w® supplied by Symphony Plastics, and/or an oxo-biodegradable material such as Reverte® supplied by Wells Plastics. The plasticizer reduces the compound's tensile modulus and improve its flexibility. In at least certain embodiments, the biodegradable plasticizer can comprise one or more biodegradable copolyesters, such as biodegradable aliphatic-aromatic copolyesters, one or more biodegradable plasticizing oils, one or more other plasticizers that can plasticize polylactic acid polymer, and mixtures thereof. The polyester biodegradable plasticizer can be a relatively low molecular weight material, such as a polyester biodegradable processing oil or a relatively high molecular weight material such as a biodegradable aliphatic-aromatic copolyester. In the latter case, the composition could be described as a polymer alloy, where the aliphatic-aromatic copolyester contribute plasticizing properties. In at least one embodiment, biodegradable aliphatic-aromatic copolyester is preferred.

In at least one embodiment, the biodegradable aliphatic-aromatic copolyester comprises a diol-dicarboxylic acid condensation-type polyester having constitutive components of an aliphatic dicarboxylic acid, an aromatic dicarboxylic acid, and an aliphatic diol. In the diol-dicarboxylic acid condensation-type polyester having constitutive components of an aliphatic dicarboxylic acid, an aromatic dicarboxylic acid and an aliphatic diol, the dicarboxylic acid-derived structural units for the repetitive units to constitute the molecule of the polyester include those of aliphatic dicarboxylic acids, aromatic dicarboxylic acids and their mixtures. In the polyester, the diol-derived structural units include those of aliphatic diols and their mixtures. Regarding the starting materials for the polymer, the diols are, for example, aliphatic diols having from 2 to 10 carbon atoms. Concretely, they include ethylene glycol, diethylene glycol, triethylene glycol, propylene glycol, dipropylene glycol, 1,3-butanediol, 1,4-butanediol, 3-methyl-1,5-pentanediol, 1,6-hexanediol, 1,9-nonanediol, neopentyl glycol, tetramethylene glycol, and 1,4-cyclohexanedimethanol. These may be used either singly or as combined.

The dicarboxylic acids for use herein may be aromatic and/or aliphatic dicarboxylic acids. The aromatic dicarboxylic acid includes phthalic acid, orthophthalic acid, isophthalic acid, and terephthalic acid. Preferred examples of the aliphatic dicarboxylic acids are oxalic acid, succinic acid, malonic acid, glutaric acid, adipic acid, pimelic acid, suberic acid, azelaic acid, undecane-diacid, dodecane-diacid, and their anhydrides. The dicarboxylic acids may be mixed with their anhydrides, and they may be used either singly or as combined.

For the constitutive components of the diol-dicarboxylic acid condensation-type polyester having the constitutive components of such an aliphatic dicarboxylic acid, an aromatic dicarboxylic acid and an aliphatic diol, it is desirable that the diol is 1,4-butanediol and the dicarboxylic acids are adipic acid and terephthalic acid. Regarding the dicarboxylic acid units in the polyester, it is more desirable that the adipic acid-derived structural units account for from 10 to 90 mol % and the terephthalic acid-derived structural units for from 10 to 90 mol %, based on the number of mols of all the diol-derived structural units in the molecule.

In certain embodiments, the weight average molecular weight (Mw) of the diol-dicarboxylic acid condensation-type polyester that has such constitutive components of an aliphatic dicarboxylic acid, an aromatic dicarboxylic acid and an aliphatic diol is as high as possible within the moldable range thereof, more preferably falling between 30,000 and 1,000,000, in other embodiments 50,000 and 750,000, and in yet other embodiments 100,000 and 500,000.

In certain embodiments the diol-dicarboxylic acid condensation-type polyester has a melt flow rate between 0.5 and 35.0 g/10 min., in other embodiments, between 1.0 and 15.0 g/10 min., and in yet other embodiments between 3.0 and 7.0 g/10 min.

In at least one embodiment, the diol-dicarboxylic acid condensation-type polyester has a tensile modulus of between 1,000 and 75,000 psi. In other embodiments, the tensile modulus is between 5,000 psi and 35,000 psi, and in yet other embodiments between 10,000 psi and 20,000 psi as measured according to ASTM D-638.

In at least one embodiment, the diol-dicarboxylic acid condensation-type polyester has a tensile strength of between 1,000 and 12,000 psi, as measured according to ISO-527. In other embodiments, the tensile strength is provided between 2,000 and 7,500, in other embodiments between 3,000 and 6,000, and in yet other embodiments between 4,000 and 5,500 psi.

The diol-dicarboxylic acid condensation-type polyester for use in the invention, which has constitutive components of an aliphatic dicarboxylic acid, an aromatic dicarboxylic acid and an aliphatic diol, may be a resin available on the market. One example of the commercially-available resin for the polyester is Eastar Bio® poly(tetramethylene adipate-co-terephthalate) available from Eastman Chemical. Another example is Ecoflex available from BASF, such as Ecoflex FBX 7011.

Other suitable polyesters that can be used include, but are not necessarily limited to, Biomax® from DuPont, and Bionolle from Showa Highpolymer Co., Ltd.

While not wishing to be bound to one theory, degradable compositions including a crystallinity inhibiting agent, such as the starch-based polymer, may provide netting having desired smoothness, such as measured using a Gurley® Model 4340 Automatic Densometer and Smoothness Tester. Any suitable starch-based polymer can be used. An example of a suitable crystallinity inhibiting agent includes Mater-Bi from Novamont.

Suitable polyolefins include polypropylene or polyethylene. In one embodiment, a particularly preferred polypropylene comprises Pro-Fax® available from Basell of Elkton, Md. In another embodiment, a particularly preferred polyethylene comprises Exxon Mobil LD-Series, available from Exxon Mobil of Houston, Tex. It is understood that other thermoplastic polyolefins may be suitable.

Suitable additives include colorant, processing aids and antioxidants as well as the friction reducing additive, such as slip and antiblock additives. Examples of these additives include Dynamar® 5911, Irganox® 1076, and Kenamide EZ.

The degradable composition can be made by any conventional process for forming these types of compositions. These processes include, but are not necessarily limited to, compounding. Generally, suitable methods for making the composition comprise compounding, either as a separate operation using a twin-screw extruder (preferred method in at least one embodiment), or in-line compounding using a single-screw extruder equipped with a screw that feature good distributive and dispersive mixing characteristics.

In at least one embodiment, the degradable composition is another biodegradable composition that has a tensile modulus of less than 280,000 psi (1,930 MPa) and in other embodiments between 80,000 psi (550 MPa) and 250,000 psi (1,725 MPa), as measured in accordance with ASTM D-882. In other embodiments, the tensile modulus is between 100,000 psi (670 MPa) and 200,000 psi (1,380 MPa). In still further embodiments, the tensile modulus is between 120,000 psi (827 MPa) and 160,000 psi (1,103 MPa).

In at least some embodiments, films made of a composition have a tensile strength of 3,500 psi (24 MPa) to 9,000 psi (50 MPa), in other embodiments of 5,000 psi (34 MPa) to 8,000 psi (55 MPa), and in yet other embodiments of 5,500 (37 MPa) to 6,500 psi (45 MPa). Tensile strength of films may be measured by ASTM D-882.

In at least some embodiments, films made of the biodegradable composition have a Gurley of 1 to 100 mg/inch, in other embodiments of 4 to 50 mg/inch, and in yet other embodiments of 10 to 25 mg/inch, as measured in accordance with ASTM D-6125-97 on 0.003 to 0.004 inch thick film.

In at least some embodiments, films made of the biodegradable composition have a yield strength of 2,500 psi (17 MPa) to 12,000 psi, (83 MPa) in other embodiments of 4,500 psi (31 MPa) to 10,000 psi (70 MPa), and in yet other embodiments of 6,000 psi (40 MPa) to 8,250 psi (56.9 MPa). Yield strength can be measured by ASTM D-882.

The friction reducing additive such as a slip and/or anti-block additive may include components having the formula [1]

R₁—CNR₂R₃ [1]

where R₁ is an alkyl, a cyclic, or an aryl substituent having a C₁₂-C₂₆ backbone, especially a C₁₆-C₂₂ backbone, R₂ and R₃ are independently selected from a hydrogen as well as, an alkyl, an aryl, or a cyclic substituent having a C₁-C₂₆ backbone. Non-limiting examples include fatty amides, such as N-stearyl erucamide, hydroxystearamide, and (Z)-13-docosenoic amide, where Z denotes cis- or trans-configurations. It is understood that other slip aids such as natural waxes, synthetic waxes, siloxanes, saturated amides, oxidized alkylenes, fluoropolymers, and combinations thereof may also be used. Further representative examples of slip and/or anti-block additives include the following: Kenamide, Kenamide EZ, 10% Erucamide/90% Ecoflex 7011, 8 wt % wax/92 wt % Ecoflex 7011, 60% calcium carbonate/40% Ecoflex 7011, 40 wt % calcium carbonate/60% Ecoflex 7011, hydroxystearamide supplied as Paricin 220 and 285, a wax/silica/PLA material supplied by and Sukano PLA as dcS511.

In other embodiments, the elastic behavior of the netting may be enhanced with a slip and/or anti-block additive. A non-limiting example of the additive is a mineral-based additive such as calcium carbonate. In certain embodiments, the additive may include an amide, an imide, and/or a lactam.

The extruded netting can be made by any suitable netting extrusion process. Suitable examples of these processes are set forth in the Background of the Invention, herein. Generally, suitable methods for making the netting comprises extruding the degradable composition through dies with reciprocating or rotating parts to form the netting configuration. This creates cross machine direction strands that cross the machine direction strands, which flow continuously. Of course, it should be understood that the degradable composition could be used to form both the cross machine direction strands and the machine direction strands, or one or part of the strands, in which case, another material such as still another biodegradable composition or an elastomeric material such as Kraton®, could be used to form the other strands. After the extrusion, the netting is then typically stretched in the machine direction using a differential between two sets of nip rollers. The stretching elongation range can be independently selected from greater than 1.25, 2, or 3 times the original length to less than 8, 7, 6, 5 or 4 times the original length. After this, the material can be stretched in the cross direction using a tentor frame. The stretching elongation range for the cross direction can be independently selected from greater than 1.25, 2, or 3 times the original length to less than 8, 7, 6, 5 or 4 times the original length. It should be understood, that the above described method is just one of many suitable methods that can be employed to manufacture extruded netting in accordance with the present invention.

In at least one embodiment, the extruded netting has a weight of between 1 to 500 g/m (grams per meter), in other embodiments between 3 to 200 g/m, in still other embodiments of 5 to 100 g/m, and in still yet other embodiments 5 to 30 g/m as measured by ASTM D-3776.

In at least one embodiment, the extruded netting has a pre-orientation crystallinity of between 1 to 12 J/g, in other embodiments between 2 to 10 J/g, and in yet other embodiments 4 to 8 J/g.

In at least one embodiment, the extruded netting has a post-orientation crystallinity of between 10 to 30 J/g (joules per gram), in other embodiments between 12 to 24 J/g, and in still yet other embodiments 14 to 18 J/g. Crystallinity, both pre- and post-orientation, can be measure by a differential scanning calorimeter.

In at least one embodiment, the extruded netting has a cross directional tensile strength of 1 to 50 kgf/4 inch, in other embodiments between 2.5 to 25 kgf/4 inch, and in yet other embodiments 4 to 15 kgf/4 inch. Cross directional tensile strength can be measured by an Instron® tensile tester.

In at least some embodiments, the extruded netting has a break strain of 10 to 1,000%, in other embodiments of 100 to 700%, and in yet other embodiments of 350 to 600%. Break strain can be measured by ASTM D-638.

The netting made in accordance with the present invention has many potential uses. Particularly, the properties of the netting make the netting of the invention particularly suitable for use as bags for consumables, such as onions and other produce. The soft feel of the bags make the netting of the present invention particularly suitable for this purpose.

Other suitable uses includes use as sod net, sod wrap, hay bale wrap, wattle net and erosion control blanket applications. The netting can also be used to form other types of composites wherein the netting is secured to at least one or more layers of material. Examples of such composites include consumer wipes, reinforced tissue towels, and erosion control composites.

The present invention may be further appreciated by consideration of the following, non-limiting examples, and certain benefits of the present invention may be further appreciated by the examples set forth below.

### Example 1

A formulation includes PLA 2002 D at 28 wt %, Ecoflex FBX 7011 at 62 wt %, and Mater-Bi 10 wt % combined as a master batch. The material of Example 1 is extruded as netting at a basis weight of 220 g/m² and a total width of 44.5 inches (1.13 m).

### Example 2

The weight percents of biodegradable compositions are shown in Table 1 below.

TABLE 1

| | | | Response 1 | Response 2 | | | Response 5 |
|---|---|---|---|---|---|---|---|
| | | | Tensile | Tensile | Response 3 | Response 4 | Yield |
| Component 1 | Component 2 | Component 3 | Strength | Modulus | Break | Gurley | Strength |
| A:PLA | B:EcoFlex | C:Mater Bi | psi | ksi | Strain % | mg/inch | psi |
| 1.0 | 0.0 | 0.0 | 11146 | 279 | 5 | 65.79 | 9971 |
| 0.8 | 0.1 | 0.1 | 8714 | 216 | 5.31 | 59.94 | 8714 |
| 0.6 | 0.3 | 0.1 | 8023 | 209 | 649 | 58.84 | 7420 |
| 0.8 | 0.1 | 0.1 | 8987 | 249 | 4.77 | 67.71 | 8987 |
| 0.4 | 0.5 | 0.1 | 6237 | 148 | 610 | 19.92 | 6237 |
| 0.5 | 0.2 | 0.3 | 5418 | 129 | 601 | 16.03 | 4995 |
| 0.35 | 0.35 | 0.3 | 5275 | 132 | 609 | 21.12 | 5275 |
| 0.2 | 0.5 | 0.3 | 5262 | 83 | 403 | 6.56 | 5484 |
| 0.4 | 0.1 | 0.5 | 5767 | 144 | 415 | 82.94 | 5613 |
| 0.2 | 0.3 | 0.5 | 5222 | 196 | 612 | 24.28 | 5154 |

The extruded netting is subsequently biaxially oriented by first stretching the extruded material in the machine direction a temperature below the glass transition temperature of the polyolefin in this case polyethylene, at a temperature of 200° F. The netting is then immediately stretched in the cross direction at a temperature of 120-175° F. The resulting biaxially oriented netting has 1.3 strands per inch in the machine direction and 0.6 strands per inch in the cross-machine direction.

The several oriented nettings made from the compositions above are then tested for aerobic biodegradation under controlled composting conditions according to ASTM D-5338-98. In a validated test, some of the inventive nettings show substantial biodegradation (>90 wt % loss) after 90 days. In addition, the composition is scored as compostable according to method ASTM D-6400.

The tensile strength and modulus of the composition are measured by ASTM D-882, the Gurley smoothness as measured by a Gurley Model 4340 automatic densometer and smoothness tester, the yield strength as measured by ASTM D-882, and the break strain as measured by ASTM D-882. The results are shown in Table 1.

### Example 3

The formulation of Example 1 additionally includes the slip and/or anti-blocking additive. While the additive is known to work well at 0.5 wt %, in this example 1 wt % of the formulation is added to be sure to reduce the variability due to processing. The masterbatch composition is prorated for the additional additive added.

The nets are tested in two angle of repose methods: sled-to-net and net-to-net. The sled-to-net test has the net placed on a flat metal platform which is attached to a hydraulic lift. A protractor with a magnetic base is attached to the platform. On the net, a two pound, flat-bottom stainless steel metal sled is set at the top. The contact surfaces are the test net and the stainless steel metal. The platform is then raised at an angle. The angle at which the net slides down the metal surface is recorded. The lower the angle at which the net slides, the lower the coefficient of friction.

The net-to-net test proceeds in the same was as the sled-to-net except that a second net of the same composition and net design configuration is added to the metal surface such that the first net and the second net are in contact with each other.

Results for the material from Example 1 and the material from Example 1 to which was added 1 wt % of Kenamide EZ from Cromptons are shown in Table 2. The difference in angles achieved in sled-to-net test and the angles for net-to-net test are statistically significant at the 99% confidence level.

TABLE 2

| | Angle At Which Slippage Begins (Degrees) | | | | | | | |
|---|---|---|---|---|---|---|---|---|
| | | Standard | Lower 3σ | Upper 3σ | | Standard | Lower 3σ | Upper 3σ |
| | Sled-to- | Deviation | Confidence | Confidence | Net-to- | Deviation | Confidence | Confidence |
| Material | Net | (σ) | Limit | Limit | Net | (σ) | Limit | Limit |
| Example 1 | 18.4 | 0.94 | 16.6 | 20.1 | 21.3 | 0.50 | 19.5 | 23.0 |
| Example 1 | 13.9 | 0.85 | 12.1 | 15.6 | 12.6 | 1.25 | 8.20 | 17.1 |
| Plus 1 wt % | | | | | | | | |
| Kenamide EZ | | | | | | | | |

### Example 4

A heavier rope netting having at least 12 g/m, more particularly, ranging from 25-50 g/m, is extruded. This netting is sufficiently strong, soft and compostable to be supplied as wattle for control of straw and similar materials which limit sediment runoff during construction, in particular, around installed drainage systems. Using high density polyethylene as the polyolefin and the material of Example 1, a 1 mm thick rope netting can be greater than 90 wt % composted within three months. This heavier rope netting has particularly and surprisingly good tensile strength and rough handling capability suitable to the wattle application.

### Example 5

The material of Example 3 is cast as a film. The film is then oriented with a 5:1 draft to orientation ratio. The film is then slit into 2 mm tapes. The tapes are knitted using a standard knitting machine.

### Example 6

The material of Example 3 is blown as a film. The film is then subsequently treated as in Example 5.

### Example 7

A thread is prepared from the inventive materials used in Examples 1 and 3 provides suitable closing thread for a header bag operation.

In the header bag operation, the netting is formed to a specific width using a hot water bath treatment. The thread is applied at the netting factory using a high speed automated sewing machine. The sewing machine shapes the header of each bag to a specific profile depending upon the type of produce to be contained such as a watermelon shape, a turkey shape, or an onion shape. The thread comprising the inventive composition does not generally fail in the sewing machine or in field service.

The above description of embodiments of the invention is merely exemplary in nature and, thus, variations thereof are not to be regarded as a departure from the spirit and scope of the invention. While the best mode for carrying out the invention has been described in detail, those familiar with the art to which this invention relates will recognize various alternative designs and embodiments for practicing the invention as defined by the following claims.

What is claimed is:

1. A degradable extruded netting, said netting comprising a plurality of oriented interconnected strands that intersect during extrusion, at least some of the strands comprising a degradable composition comprising:
a stiffening agent;
a degradable material; and
a crystallinity inhibiting agent.

2. The netting of claim 1, wherein at least 60% of the strands are made of the degradable composition.

3. The netting of claim 1, wherein essentially 100% of the strands are made of the degradable composition.

4. The netting of claim 1, wherein the stiffening agent comprises a polylactic acid polymer, the degradable material comprises a polyester degradable plasticizer, and the crystallinity inhibiting agent comprises a starch-based polymer, wherein the degradable composition comprises 10 to 70 weight percent polylactic acid polymer, 15 to 75 weight percent polyester degradable plasticizer, and 5 to 30 weight percent starch-based polymer.

5. The netting of claim 1, wherein the stiffening agent comprises a polylactic acid polymer, the degradable material comprises a polyester degradable plasticizer, and the crystallinity inhibiting agent comprises a starch-based polymer, wherein the degradable composition comprises 15 to 40 weight percent polylactic acid polymer, 20 to 65 weight percent polyester degradable plasticizer, and 5 to 20 weight percent starch-based polymer.

6. The netting of claim 5, wherein the degradable composition has a tensile strength of greater than 3000 psi, as measured in accordance with ASTM D-882.

7. The netting of claim 5, wherein the degradable composition has a tensile modulus of greater than 70,000 psi, as measured in accordance with ASTM D-882.

8. The netting of claim 1, further comprising a friction reducing additive.

9. The netting of claim 8, wherein the netting has a friction value of at least one of a sled-to-net angle at which slippage begins at less than 20.1 degrees or a net-to-net angle at which slippage begins at less than 23.0 degrees.

10. The netting of claim 8, wherein the friction reducing additive is selected from a group consisting of a mineral-based additive, a siloxane, a saturated amide, an oxidized alkylene, a fatty amide, an additive having a formula
R₁—CNR₂R₃
where R₁ comprises an alkyl, a cyclic, or an aryl substituent having a C₁₂ to C₂₆ backbone, and R₂ and R₃ are independently selected from an alkyl, a cyclic, or an aryl substituent having a C₁-C₂₆ backbone or a hydrogen.

11. The netting of claim 10, wherein the netting comprises a ruckable bag.

12. The netting of claim 1, wherein the degradable material comprises a material selected from at least one of a biodegradable material, an oxo-degradable material, or an oxo-biodegradable material.

13. The netting of claim 12, wherein at least one of the degradable composition is selected from the biodegradable material comprising an aliphatic aromatic co-polyester, the stiffening agent comprising a polylactic acid, or the crystallinity inhibiting agent comprising a starch-based polymer.

14. The netting of claim 1, further comprising an amount of polyolefin present in an amount of no more than 20 weight percent.

15. A method of making a degradable extruded netting, said method comprising interconnecting and orienting a plurality of strands wherein at least some of the strands comprise a degradable composition comprising polylactic acid polymer, polyester degradable plasticizer, and starch-based polymer.

16. The method of claim 15, wherein the step of interconnecting comprises extruding a first set of strands in a first direction and extruding a second set of strands in a second direction so that the second set of strands intersect the first set of strands.

17. A composite, said composite comprising:
the netting of claim 1, the netting having a first side and a second side, opposite the first side; and
a first layer of material secured to the first side of the netting.

18. The netting of claim 1, wherein the netting comprises at least one of a produce bag, an erosion control netting or a wattle.

19. A degradable extruded netting, said netting comprising a plurality of oriented tapes, at least some of the tapes comprising a degradable composition comprising a stiffening agent, a degradable material, and a crystallinity inhibiting agent, the degradable extruded netting having a least one of a tensile strength greater than 5000 psi, a tensile modulus greater than 96,000 psi, an angle at which slippage begins of less than 20.1 degrees when measured by a sled-to-net test, or an angle at which slippage begins of less than 23.0 degrees when measured by a net-to-net test.

20. The degradable extruded netting of claim 19, further comprising at least one of a slip or an anti-blocking agent comprising at least one of a mineral-based additive, a fatty amide, or an additive having a formula
R₁—CNR₂R₃
where R₁ comprises an alkyl, a cyclic, or an aryl substituent having a C₁₂ to C₂₆ backbone, and R₂ and R₃ are independently selected from an alkyl, a cyclic, or an aryl substituent having a C₁-C₂₆ backbone or a hydrogen.
